(19) United States
(12) Patent Application Publication
(10) Pub. No.: US 2020/0361272 A1
(43) Pub. Date: Nov. 19, 2020

(54) ANTI-SWAY BAR DISCONNECT SYSTEM

(71) Applicant: Wayne Peter Jackson, Mundingburra (AU)

(72) Inventor: Wayne Peter Jackson, Mundingburra (AU)

(21) Appl. No.: 16/944,366

(22) Filed: Jul. 31, 2020

Related U.S. Application Data
(63) Continuation-in-part of application No. 15/344,953, filed on Nov. 7, 2016, now Pat. No. 10,744,841.

(30) Foreign Application Priority Data
Nov. 6, 2015 (AU) 2015904567

(51) Int. Cl. B60G 21/10

(52) U.S. Cl. CPC B60G 21/106; B60G 2300/124; B60G 2202/413; B60G 2202/135; B60G 2202/412; B60G 2300/07

(57) ABSTRACT

An anti-sway bar assembly for a vehicle. The anti-sway bar assembly including: a first anti-sway bar member associated, at a first end thereof, with a first wheel of the vehicle; a second anti-sway bar member associated, at a first end thereof, with an opposed second wheel of the vehicle; and a connection assembly associated with a second end of each of the first anti-sway bar member and the second anti-sway bar member, the connection assembly configured for movement between a use condition in which the first anti-sway bar member and the second anti-sway bar member are connected to one another, and a released condition in which the first anti-sway bar member and the second anti-sway bar member are disconnected from one another.

### TECHNICAL FIELD

The present invention relates to an anti-sway bar disconnect system for use in vehicle, particularly a quad bike or other off road vehicle.

### BACKGROUND ART

An anti-sway or anti-roll bar is intended to force each side of the vehicle to lower, or rise, to similar heights, to reduce the sideways tilting (roll) of the vehicle on curves, sharp corners, or large bumps.

Although there are many variations in design, a common function is to force the opposite wheel's shock absorber, spring or suspension rod to lower, or rise, to a similar level as the other wheel. In a fast turn, a vehicle tends to drop closer onto the outer wheels, and the anti-sway bar soon forces the opposite wheel to also get closer to the vehicle. As a result, the vehicle tends to “hug” the road closer in a fast turn, where all wheels are closer to the body. After the fast turn, then the downward pressure is reduced, and the paired wheels can return to their normal height against the vehicle, kept at similar levels by the connecting anti-sway bar.

A negative side-effect of connecting pairs of wheels is that a jarring or bump to one wheel tends to also jar the opposite wheel, causing a larger impact applied across the whole width of the vehicle. A vehicle that runs over several potholes scattered in the road tends to rock side-to-side, or waddle, due to the action of the bar at each pair of wheels. Other suspension techniques can delay or dampen this effect of the connecting bar, as when hitting small holes that momentarily jolt a single wheel, whereas larger holes or longer tilting then tugs the bar with the opposite wheel.

A conventional anti-sway bar is usually a torsion spring that resists body roll motions. It is usually constructed out of a cylindrical steel bar, formed into a “U” shape that connects to the body at two points, and at the left and right sides of the suspension. If the left and right wheels move together, the bar rotates about its mounting points. If the wheels move relative to each other, the bar is subjected to torsion and forced to twist. Each end of the bar is connected to an end link through a flexible joint. The anti-sway bar end link connects in turn to a spot near a wheel or axle, transferring forces from a heavily-loaded axle to the opposite side.

The bar resists the torsion through its stiffness. The stiffness of an anti-roll bar is proportional to the stiffness of the material, the fourth power of its radius, and the inverse of the length of the lever arms (i.e., the shorter the lever arm, the stiffer the bar). Stiffness is also related to the geometry of the mounting points and the rigidity of the bar's mounting points. The stiffer the bar, the more force required to move the left and right wheels relative to each other. This increases the amount of force required to make the body roll.

Excessive roll stiffness, typically achieved by configuring an anti-roll bar too aggressively, can make the inside wheels lift off the ground during hard cornering. This can be used to advantage: many front wheel drive production cars lift a rear wheel when cornering hard in order to overload the opposite wheel, limiting understeer.

There are active anti-sway systems that are controlled by a controller provided linked to the suspension ECU or body sensors and electric motors. There are even systems that can be used to disengage the stabilizer bars when off-road, allowing for greater vehicle articulation and ride quality. Most prior art system include an elaborate array of linkages, cables and levers or complex components that are prone to the elements and to damage by rocks, mud, sand, being hit by sticks and so on.

Some attempts have been made to overcome these problems. For instance, U.S. Pat. No. 5,630,623 describes a hydraulic vehicle roll control system that includes an actuator connected between an unsprung portion of a vehicle and a sprung portion of the vehicle. However, this system is relatively complex and bulky, requiring the presence of a hydraulic fluid reservoir, pressure control valves and check valves. Thus, there would be an advantage if it were possible to provide an anti-sway bar disconnect system that not only disconnects the anti-sway bar quickly and easily when required, but also reduced the weight and complexity of anti-sway bar disconnect systems such as that described in U.S. Pat. No. 5,630,623.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an anti-sway bar disconnect system, which may at least partially overcome at least one of the abovementioned disadvantages or provide the consumer with a useful or commercial choice.

In one aspect, the invention resides broadly in an anti-sway bar assembly for a vehicle, the anti-sway bar assembly including:

A first anti-sway bar member associated, at a first end thereof, with a first wheel of the vehicle;

A second anti-sway bar member associated, at a first end thereof, with an opposed second wheel of the vehicle; and

A connection assembly associated with a second end of each of the first anti-sway bar member and the second anti-sway bar member, the connection assembly configured for movement between a use condition in which the first anti-sway bar member and the second anti-sway bar member are connected to one another, and a released condition in which the first anti-sway bar member and the second anti-sway bar member are disconnected from one another.

The first anti-sway bar member may be associated with the first wheel in any suitable manner. For instance, the first anti-sway bar member may be directly connected to the first wheel. More preferably, however, the first anti-sway bar member may be indirectly connected to the first wheel. In this embodiment of the invention, it is envisaged that the first anti-sway bar member may be associated with an axle to which the first wheel is connected. The first anti-sway bar member may be directly connected to the axle, or may be indirectly connected to the axle such as via one or more intermediate connection members or the like.

The second anti-sway bar member may be associated with the second wheel in any suitable manner. For instance, the second anti-sway bar member may be directly connected to the second wheel. More preferably, however, the second anti-sway bar member may be indirectly connected to the second wheel. In this embodiment of the invention, it is envisaged that the second anti-sway bar member may be associated with an axle to which the second wheel is connected. The second anti-sway bar member may be directly connected to the axle, or may be indirectly connected to the axle such as via one or more intermediate connection members or the like. In a preferred embodiment of the invention, the axle with which the first anti-sway bar member is associated is the same axle with which the second anti-sway bar is associated.

Thus, the first wheel and the second wheel are, in this embodiment of the invention, provided at opposed ends of the same axle.

The first anti-sway bar member and the second anti-sway bar member may be fabricated as separate members. Alternatively, the first anti-sway bar member and the second anti-sway bar member may comprise portions of the same anti-sway bar. In this embodiment of the invention, it is envisaged that an anti-sway bar may be split into the first anti-sway bar member and the second anti-sway bar member using any suitable technique.

In a preferred embodiment of the invention, the anti-sway bar may be the anti-sway bar fitted to the vehicle by the vehicle manufacturer. Alternatively, the anti-sway bar may be retrofitted to the vehicle in order to replace the anti-sway bar fitted to the vehicle by the vehicle manufacturer.

The anti-sway bar may simply be split into two pieces (for instance, by cutting the anti-sway bar). Alternatively, a portion of the anti-sway bar may be removed so that the second ends of both the first anti-sway bar member and the second anti-sway bar member are spaced apart from one another in use.

The first anti-sway bar member and the second anti-sway bar member may be of substantially the same length as one another. In this embodiment, the connection assembly may be located substantially equidistant from each of the first wheel and the second wheel. Alternatively, the first anti-sway bar member and the second anti-sway bar member may be of different lengths to one another. In this way, the connection assembly may be located closer to one of the first wheel or the second wheel. It will be understood that the relative lengths of the first anti-sway bar member and the second anti-sway bar member is not critical to the working of the invention and may be chosen based on factors including where the most convenient location for the connection assembly may be depending on the construction of the vehicle, ease of access for maintenance and so on.

As previously stated, the connection assembly is associated with the second ends of both the first anti-sway bar member and the second anti-sway bar member. The connection assembly may be associated with the second ends of the first anti-sway bar member and the second anti-sway bar member in any suitable manner. In some embodiments of the invention, the connection assembly may comprise a first connection portion configured for connection to the first anti-sway bar member and a second connection portion configured for connection to the second anti-sway bar member. The first connection portion and the second connection portion may be connected to the respective anti-sway bar members in any suitable manner. For instance, the first connection portion and the second connection portion may be fixedly connected to the respective anti-sway bar members using any suitable joining technique, such as welding, brazing or the like. Alternatively, the first connection portion and the second connection portion may be connected to the respective anti-sway bar members using one or more mechanical fasteners (bolts, nails, screws, rivets, staples or the like, or any suitable combination thereof).

In other embodiments of the invention, the first connection portion and the second connection portion may be engaged with the respective anti-sway bar members in any suitable manner. For instance, the first connection portion and the second connection portion may be engaged with the respective anti-sway bar members via a frictional engagement, a screw-threaded engagement, a locking engagement or the like, or any suitable combination thereof.

In a preferred embodiment of the invention, the second end of the first anti-sway bar member and/or the second anti-sway bar member may be provided with a screw-threaded portion configured to engage with a complementary screw-threaded portion on the first connection portion and/or the second connection portion. In some embodiments of the invention, the second ends of the first anti-sway bar member and the second anti-sway bar member may be provided with an internally screw-threaded portion configured to engage with an external screw-thread on the first connection portion and the second connection portion, respectively. In this embodiment of the invention, the internally screw-threaded portion may extend into the first anti-sway bar member and/or the second anti-sway bar member from the second ends thereof. Thus, the internally screw-threaded portions may comprise internally screw-threaded bores extending into the anti-sway bar members and positioned substantially coaxially therewithin.

The external screw thread may be formed integrally as part of the first connection and the second connection portion or may comprise an externally screw-threaded fastener (such as a screw or bolt) configured to connect the connection portion to the anti-sway bar member. In embodiments of the invention in which an externally screw-threaded fastener is used, one or more sealing members (washers, gaskets or the like) may be used to prevent the passage of fluid (such as water, air or oil) from the connection assembly into the internal screw-threaded portion of the anti-sway bar member.

In a preferred embodiment of the invention, the second ends of the first anti-sway bar member and/or the second anti-sway bar member may be configured to be received and retained in a receiving portion of the first connection portion and the second connection portion. Thus, an end region of the first anti-sway bar member and/or the second anti-sway bar member may be shaped so as to be received and retained in the receiving portion of the first connection member and the second connection member. The end region of the first anti-sway bar member and/or the second anti-sway bar member may be shaped in any suitable manner. For instance, the diameter of the end regions may be less than the diameter of the remainder of the first anti-sway bar member and the second anti-sway bar member. Alternatively, or in addition to, the end regions of the first anti-sway bar member and/or the second anti-sway bar member may be provided with one or more retention members configured to enhance the retention of the first anti-sway bar member and/or the second anti-sway bar member within the retention portions of the first connection portion and the second connection portion. Any suitable retention members may be provided. For instance, the retention members may comprise one or more adhesive patches, catches, locking members or the like. More preferably, an outer surface of the end region of the first anti-sway bar member and/or the second anti-sway bar member may be provided in the form of a splined surface. Alternatively, one or more keys (such as, but not limited to, one or more Woodruff keys) may be provided in the outer surface of the end region of the first anti-sway bar member and/or the second anti-sway bar member. In embodiments of the invention in which the outer surface of the end regions is a splined surface, it is envisaged that the inner surface of the receiving portion of the first connection portion and/or the second connection portion may be provided in the form of a splined surface. In this way, the ability of the connection portions to rotate relative to the anti-sway bar members may be reduced or eliminated.

In some embodiments of the invention, the first connection portion and the second connection portion may be configured to connect to one another in the use condition, and to disconnect from one another in the released condition. Preferably, however, the first connection portion and the second connection portion may be configured to be retained in connection with one another in both the use condition and the released condition. Thus, in this embodiment of the invention, the first connection portion and the second connection portion may together define a housing of the connection assembly.

The first connection portion and the second connection portion may be retained in connection with one another using any suitable technique. For instance, one or more adhesives, clips, clamps, clasps or the like may be used. In an alternative embodiment of the invention, the first connection portion and the second connection portion may be retained in connection with one another using one or more mechanical fasteners.

While it is envisaged that the housing of the connection assembly could be provided in the form of a unitary structure, it is preferred that the housing is fabricated from a first connection portion and a second connection portion in order to allow for ready access to the interior of the housing, such as for maintenance or repair.

In a preferred embodiment of the invention, the housing of the connection assembly defines a cavity therewithin. It is envisaged that the connection assembly may further comprise an actuation mechanism located within the housing and, more specifically, within the cavity defined at the interior of the housing.

The actuation mechanism may be of any suitable form, although it is envisaged that the actuation mechanism may be configured to move the anti-sway bar assembly between the use condition and the released condition. In a preferred embodiment of the invention, the actuation mechanism includes one or more engagement members configured to engage with an inner surface of the housing so as to effectively connect the first anti-sway bar member to the second anti-sway bar member via the connection assembly. The engagement member may be of any suitable form. However, in a preferred embodiment of the invention, the engagement member may comprise a piston configured for movement relative to the housing. The piston may be movable between an engaged condition (in which the piston is engaged with and retained on the inner surface of the housing) and a disengaged condition (in which the piston is disengaged from the inner surface of the housing). The piston may be retained in engagement with the inner surface of the housing in any suitable manner. For instance, the engagement member may comprise one or more adhesive patches, catches, locking members or the like. More preferably, an outer surface of the piston may be provided in the form of a splined surface. In this embodiment of the invention, the splined outer surface of the engagement member may be configured to engage with a splined inner surface of the housing in the engaged condition.

It is envisaged that the engaged condition of the engagement member may correspond to the use condition of the anti-sway bar system. Thus, when the engagement member is in the engaged condition, both the first anti-sway bar member and the second anti-sway bar member may be connected to one another via the connection assembly and may therefore rotate in concert with one another.

In a preferred embodiment of the invention, the engagement member may be biased into the engaged condition. Thus, the engagement member may be associated with one or more biasing members, such as, but not limited to, one or more springs, portions of compressible material or the like. Preferably, the engagement member may be biased into the engaged condition by the natural bias of the biasing members. In order to move the engagement member form the engaged condition to the disengaged condition, it is envisaged that the natural bias of the biasing members must be overcome so that the engagement member may be moved out of engagement with the inner surface of the housing and into the disengaged condition.

Although the engagement member may move in any suitable direction, it is envisaged that the engagement member moves in a substantially linear manner between the engaged condition and the disengaged condition. In a preferred embodiment of the invention, the engagement member moves substantially parallel to a longitudinal axis of the connection assembly.

The engagement member may be moved from the engaged condition to the disengaged condition in any suitable manner. Preferably, however, the actuation mechanism may be provided with an actuation member configured to actuate movement of the engagement portion. The actuation member may be of any suitable form, although in a preferred embodiment of the invention, the actuation member may comprise a piston. Preferably, the actuation member may abut the engagement member, such that movement of the actuation member relative to the housing produces a corresponding movement of the engagement member.

Movement of the actuation member relative to the housing may be achieved using any suitable technique. For instance, a motor may be used to drive movement of the actuation member relative to the housing. Alternative, a working fluid may be used to move the actuation member relative to the housing. It is envisaged that the actuation member may be contained within a cylinder. The cylinder may be of any suitable size, shape or configuration, although in a preferred embodiment of the invention the cylinder may be defined by the inner surface of the housing and the engagement member. In another embodiment of the invention, a sleeve member may be located within the housing to form the cylinder, and the actuation member may be located within the sleeve member. In this embodiment of the invention it is envisaged that the sleeve member may be configured to rotate relative to the housing (and in concert with one of the anti-sway bar members) when the connection assembly is in the release condition.

In a preferred embodiment of the invention, the working fluid may be introduced to the cylinder in order to move the actuation member relative to the housing. More preferably, the pressure of the working fluid may move the actuation portion relative to the housing, thereby causing a corresponding movement of the engagement member relative to the housing against the bias of the biasing members and into the disengaged condition. The working fluid may be extracted from the cylinder in order to move the actuation member (and therefore the engagement member) into the engaged condition.

In some embodiments of the invention, a working fluid reservoir may be provided in fluid communication with one or more working fluid connection ports on the housing via the actuable control valve whereby the actuable control valve is operable to maintain the system in a release condition whereby working fluid in the cylinder maintains the engagement member disengaged from the housing and a use condition in which the actuable control valve allows the working fluid in the cylinder to exit the cylinder, thereby allowing the engagement member to be biased into engagement with the housing.

In a preferred embodiment, the anti-sway bar assembly may further comprise an actuable control valve configured for controlling the movement of the working fluid within the assembly. The control valve of the preferred embodiment is preferably controlled by a manually actuable switch or similar provided relative to the driver of the vehicle such that the driver can remotely lock and unlock the anti-sway bar as desired.

The control valve of the system of the present invention is also preferably connected to the vehicle power source in order to power the control valve as required.

The system of the present invention is typically provided for off-road vehicles or rough terrain vehicles. The system of the present invention can be used on the front and/or rear anti-sway bars of a vehicle. Where more than one anti-sway bar assembly is provided, the assemblies may be separately actuable or actuable together depending upon the user preference and/or situation.

Although the manually actuable switch is a particularly preferred embodiment, the system of the present invention may be actuated or switched between the use and release conditions in other situations or using other mechanisms. For example, the system may be released when the transmission of the vehicle is placed in low range (by the user) and then moved into the use condition when the transmission is placed into high range. Still further, a speed sensor may be used to move the system between the use and release conditions or vice versa. A speed sensor may for example prevent release of the system above certain speeds and/or the system may automatically move to the use condition at a threshold speed for example, approximately 20 km/h.

As previously stated, the system of the present invention may include a working fluid but the system can be either pneumatic or hydraulic. It is preferred that the working fluid system is substantially sealed except for a fluid breather port provided in the preferred hydraulic version, normally in association with the fluid reservoir.

The system of the present invention includes an actuable control valve. Preferably, the control valve is electrically powered and therefore, it can simply utilise the power source of the vehicle. Any type of control valve can be used. Generally however the control valve will be relatively small as the volume of the cylinder will typically be quite small and it will also allow the control valve to be mounted relative to the vehicle more easily.

The control valve will preferably include at least one port to connect to the fluid reservoir. The fluid may be pumped or gravity fed from the reservoir to the control valve. The movement of the piston within the cylinder when in the unlocked condition may act to pump fluid. The control valve will also preferably include a pair of ports, one connected to each of the ports on the cylinder, typically using connection hoses or lines. More ports may be provided if more than one cylinder assembly is provided or alternatively, only two ports may be provided and other forms of connection may be used to connect more than one cylinder to the respective ports of the control valve.

A solenoid is typically provided to control the opening and closing of each of the ports provided on the control valve. Preferably, the solenoid is electrically powered and can be powered from the vehicle power source. Typically, the solenoids are controlled, normally manually, by the user/driver and/or by other mechanisms as outlined above.

The system of the present invention also includes at least one cylinder and piston assembly connected to the anti-sway bar and a fluid connection port at both ends of the cylinder. Generally, the system is provided such that one fixed arm is provided on one end of the anti-sway bar and one cylinder and piston assembly is provided on the other end of the anti-sway bar.

As mentioned, the cylinder and piston assembly will preferably include a cylinder and a piston which is reciprocally movable within the cylinder with the piston is mounted relative to an elongate rod. An attachment point is preferably provided on the elongate rod and a second attachment point is preferably provided on or relative to the cylinder in order to mount the cylinder and piston assembly to the anti-sway bar and a transverse arm mounting the wheel of the vehicle.

The cylinder will preferably include an elongate body, which is preferably tubular. The cylinder will normally have open ends and a pair of end caps is preferably provided, one at either end of the cylinder. The end caps are preferably threaded to allow the end caps to be removed from the cylinder such as for maintenance and the like. One of the end caps, normally at the end of the cylinder positioned lower in use, will preferably have an opening therethrough to allow the rod associated with the piston to move relative to the cylinder and in order to change the overall length of the cylinder and piston assembly.

A fluid connection port is preferably provided in each of the end caps. Normally, a fluid connection hose or conduit will be provided between the fluid connection port of the end caps and the fluid connection port of the control valve.

Typically, the cylinder and piston assembly is length-matched to the fixed arm such that the piston is located approximately part way along the cylinder when the cylinder and piston assembly is in the locked condition with working fluid located on both sides of the piston in order to hold the piston in position.

In use, when the cylinder and piston assembly is in the locked condition, the working fluid, preferably a non-compressible fluid is located to either side of the piston within the cylinder which will effectively substantially prevent movement of the piston within the cylinder which locks the length of the cylinder and piston assembly. In the unlocked condition, the fluid will typically be removed from the cylinder which allows the piston to freely move within the cylinder.

The system of the present invention includes a working fluid reservoir. Normally, the fluid reservoir will be used for a hydraulic fluid of which there are many types commercially available. The fluid reservoir is normally sufficiently large to hold not only the volume of fluid used in any one or more cylinders in the system in the locked condition, but also some excess fluid.

The fluid reservoir can be provided in any physical location relative to the other components but access to the fluid reservoir by the working fluid in the system is through the control valve. Normally, the working fluid reservoir will be mounted to or relative to a chassis of the vehicle. As mentioned above, the fluid reservoir is preferably connected to the control valve via one or more hoses or hydraulic lines.

The fluid reservoir can have any suitable shape, and can be made from any suitable material.

According to a particularly preferred embodiment, a breather is provided on the fluid reservoir to allow fluid flowing from the cylinder to the reservoir to displace any air the reservoir and to allow air to be drawn into the reservoir when the fluid is driven back to the cylinder when it assumes the locked condition. The breather will also preferably prevent or minimise detritus from entering the fluid reservoir through the breather and also any insect life or undesirable material.

As mentioned above, in the locked condition, the control valve will be actuated so that fluid is provided to the cylinder to fix the piston within the cylinder substantially in position relative to the cylinder to effectively substantially fix the overall effective length of the cylinder and piston assembly. In the locked condition, the cylinder and piston assembly will effectively act as a solid link.

When actuated, the control valve will allow fluid to be removed from the cylinder which allows the piston free travel within the cylinder whether displacing hydraulic fluid to or from the reservoir or not. This will unlock the cylinder and piston assembly allowing the one of the wheels relative to which the anti-sway bar is connected to move independently of the other as well as providing an increased wheel travel.

A user can therefore lock and unlock the anti-sway bar as they require or desire to fit different circumstances.

Use of some fluids may require the use of a pump in order to move the fluid around the components of the system. Therefore, the system of the present invention may include a pump in order to ensure that the working fluid that has exited the cylinder in the unlocking process, can be returned to the cylinder as required and may indeed move the fluid about the system as required. The pump may be used for a pneumatic system but is typically not required for a hydraulic system.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a view from the rear of a quad-bike with a system according to a preferred embodiment of the present invention installed thereon.

FIG. 2 is a detail view of the portion identified as “A” in FIG. 1.

FIG. 3 is a detail view of the portion identified as “B” in FIG. 1.

FIG. 4 is a schematic view of the system of the present invention according to a preferred embodiment.

FIG. 5 is a schematic view of an anti-sway bar assembly according to an embodiment of the present invention.

FIG. 6 is a schematic view of a first anti-sway bar member and a second anti-sway bar member according to an embodiment of the present invention.

FIG. 7 is a cross-sectional view of an anti-sway bar assembly according to an embodiment of the present invention.

### DETAILED DESCRIPTION

According to a particularly preferred embodiment of the present invention, a hydraulic anti-sway bar disconnect system 10 is provided.

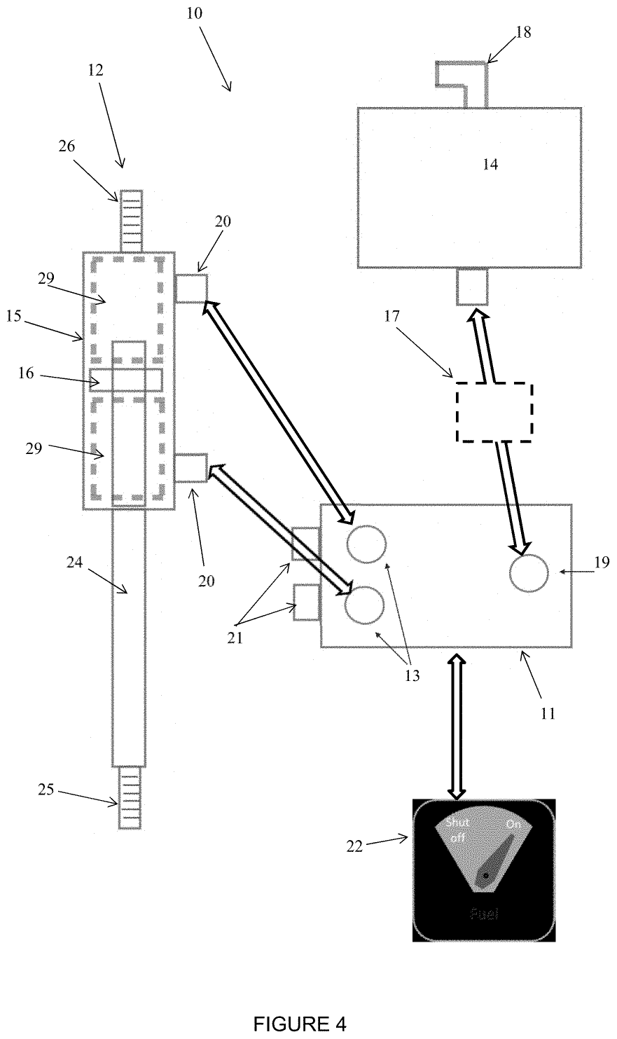

The anti-sway bar disconnect system 10 illustrated schematically in FIG. 4 includes an actuable control valve 11 for controlling the movement of a working fluid within the system, at least one cylinder and piston assembly 12 connected to the anti-sway bar having a working fluid connection port 13 at both ends of the cylinder, a working fluid reservoir 14 in fluid connection with the working fluid connection ports 13 on the at least one cylinder via the actuable control valve 11 whereby the actuable control valve 11 is operable to maintain the system in a locked condition whereby working fluid in the cylinder 15 maintains the piston 16 substantially in position and an unlocked condition in which the actuable control valve 11 allows the working fluid in the cylinder 15 to exit the cylinder 15 giving the piston 16 free travel in the cylinder 15.

The control valve 11 of the preferred embodiment is preferably controlled by a manually actuable switch 22 provided relative to the driver of the vehicle such that the driver can remotely lock and unlock the anti-sway bar as desired.

The control valve 11 of the system of the present invention is also preferably connected to the vehicle power source in order to power the control valve as required.

It is preferred that the working fluid system is substantially sealed except for a fluid breather port 18 provided in association with the fluid reservoir 14.

The control valve 11 of the preferred embodiment electrically powered and therefore, they can simply utilise the power source of the vehicle. Any type of control valve can be used. Generally however both will be relatively small as the volume of the cylinder 15 will typically be quite small and it will also allow the control valve 11 to be mounted relative to the vehicle more easily.

The control valve 11 includes port 19 to connect to the fluid reservoir 14. The fluid may be pumped or gravity fed from the reservoir 14 to the control valve 11.

As illustrated in FIG. 4, the control valve 11 includes a pair of ports 13, one connected to each of the ports 20 on the cylinder 15, typically using connection hoses or lines.

A solenoid 21 is provided for each port 13 to control the opening and closing of each of the ports 13 provided on the control valve 11. In the preferred embodiment, the solenoid 21 is electrically powered and can be powered from the vehicle power source. Typically, the solenoids 21 are controlled by the user/driver utilising the switch 22.

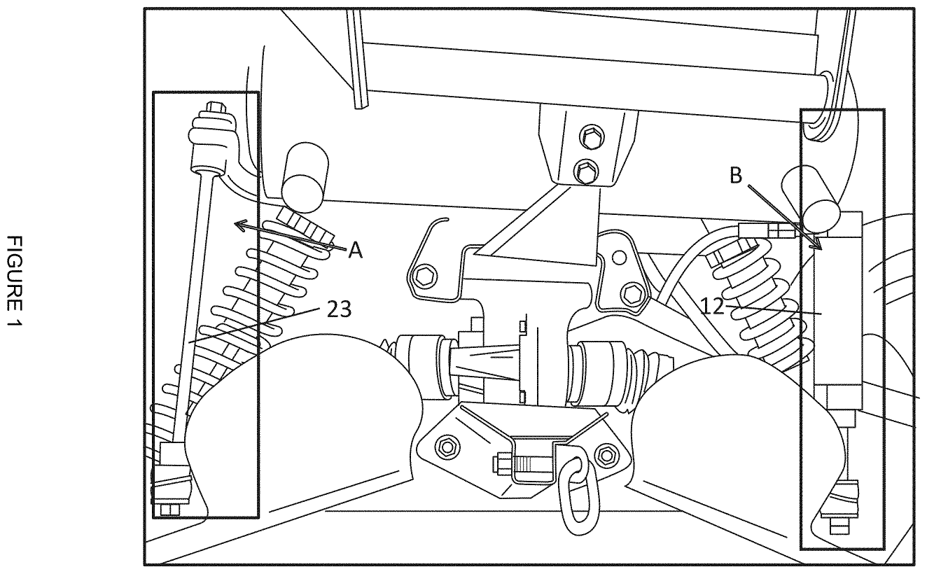

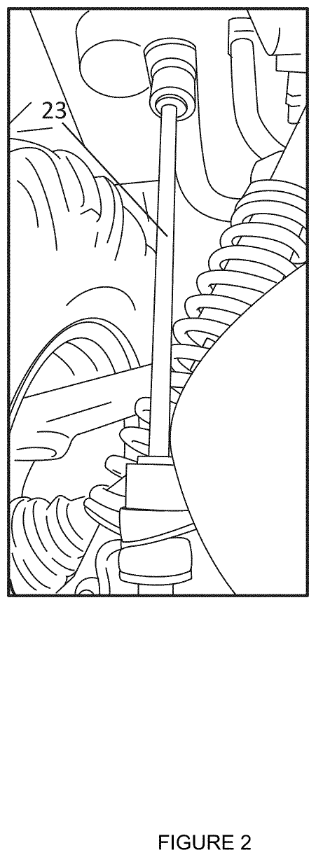

As illustrated in FIGS. 1 to 3, the system of the preferred embodiment is provided such that one fixed arm 23 is provided on one end of the anti-sway bar of the vehicle and one cylinder and piston assembly 12 is provided on the other end of the anti-sway bar.

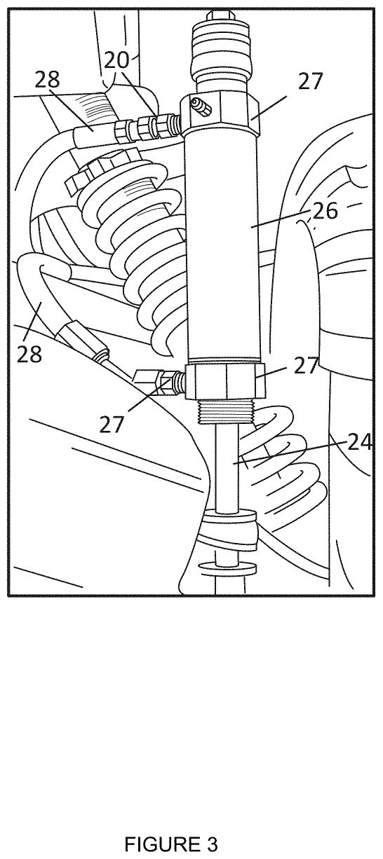

Each cylinder and piston assembly 12 includes a cylinder 15 and a piston 16 which is reciprocally movable within the cylinder 15 with the piston 16 mounted relative to an elongate rod 24. An attachment point 25 is preferably provided on the elongate rod 24 and a second attachment point 24 is preferably provided on or relative to the cylinder 15 in order to mount the cylinder and piston assembly 12 to the anti-sway bar and a transverse arm mounting the wheel of the vehicle as illustrated in FIGS. 1 and 3 in particular.

The cylinder 15 includes an elongate tubular body 26 with open ends and a pair of end caps 27 are provided, one at either end of the cylinder 15 as shown in FIG. 3 in particular. The end caps 27 are threaded to allow the end caps 27 to be removed from the cylinder 15 such as for maintenance and the like. The lower end cap has an opening therethrough to allow the rod 24 associated with the piston 16 to move relative to the cylinder 15 and in order to change the overall length of the cylinder and piston assembly 12.

A fluid connection port 20 is provided in each of the end caps 27. Normally, a fluid connection hose or conduit 28 is provided between the fluid connection port 20 of the end caps 27 and the fluid connection port 13 of the control valve 11.

Typically, the cylinder and piston assembly 12 is length-matched to the fixed arm 13 such that the piston 16 is located approximately part way along the cylinder 15 when the cylinder and piston assembly 12 is in the locked condition with working fluid 29 located on both sides of the piston 16 in order to hold the piston 16 in position.

In use, when the cylinder and piston assembly is in the locked condition such as is illustrated in FIG. 4, the non-compressible working fluid is located to either side of the piston 16 within the cylinder 15 which will effectively substantially prevent movement of the piston 16 within the cylinder 15 which locks the length of the cylinder and piston assembly 12. In the unlocked condition, the fluid will typically be removed from the cylinder which allows the piston to freely move within the cylinder.

Normally, the fluid reservoir 14 will be used for a hydraulic fluid of which there are many types commercially available. The fluid reservoir 14 is normally sufficiently large to hold not only the volume of fluid used in any one or more cylinders in the system in the locked condition, but also some excess fluid.

The fluid reservoir 14 can be provided in any physical location relative to the other components but access to the fluid reservoir by the working fluid in the system is through the control valve. Normally, the working fluid reservoir will be mounted to or relative to a chassis of the vehicle. As mentioned above, the fluid reservoir is preferably connected to the control valve via one or more hoses or hydraulic lines.

The breather 18 provided on the fluid reservoir 14 allows fluid flowing from the cylinder 15 to the reservoir 14 to displace air from the reservoir 14 and to allow air to be drawn into the reservoir 14 when the fluid is driven back to the cylinder 15 when it assumes the locked condition. The breather 18 will also preferably prevent or minimise detritus from entering the fluid reservoir through the breather and also any insect life or undesirable material.

According to the preferred embodiment, the hydraulic fluid reservoir 14 is positioned approximately 250 mm above the hydraulic cylinder 12 and approximately 150 mm above the control valve 11. The hydraulic circuit is completely filled with hydraulic fluid and the air is bled out of the system. The hydraulic cylinder 12 is normally fitted with bleeder nipples for this purpose.

When the sway bar disconnect is in locked position, the hydraulic fluid is on both sides of the piston 16 in hydraulic cylinder 15. The piston 16 has special seals to stop the hydraulic fluid from leaking past the piston in the cylinder 15. The control valve 11 is in a locked position, so no hydraulic fluid can move in any direction. In effect the cylinder 12 is locked (as the hydraulic fluid cannot be compressed). This makes the cylinder 12 function as a solid rod.

When the switch 22 is flicked to sway bar disconnect, 12 Volt solenoids in the control valve 11 are opened. This allows hydraulic fluid free movement between the hydraulic cylinder 12 (through the control valve 11) and the reservoir 14. If the shaft 24 moves in a more compressed direction, the fluid on one side of the piston 16 is pushed back through the hydraulic hoses 28 via the control valve 11 to reservoir 14. The hydraulic fluid on the other side of the piston 16 can flow to fill the hydraulic cylinder 15 by gravity as the fluid reservoir 14 and control valve 11 are above the hydraulic cylinder 12. Fluid movement is also assisted by the suction of the piston 16 moving in the hydraulic cylinder 15. So the piston 16 effectively acts as a hydraulic pump. As the piston 16 moves in the cylinder 15, fluid is pushed and sucked. In suction phase, the fluid is assisted by gravity.

The hydraulic fluid preferred for this application is a hydraulic oil of 10 W viscosity which is very light and thin and quick to move around in a hydraulic system. As the sway bar disconnect is preferably used at very low speeds in very uneven terrain, the piston 16 and shaft (which are connected to the vehicle suspension arm) move slowly in the cylinder 15. This slow movement means that the hydraulic oil movement created by the piston 16 and suction is adequate.

As mentioned above, in the locked condition, the control valve will be actuated so that fluid is provided to the cylinder to fix the piston within the cylinder substantially in position relative to the cylinder to effectively substantially fix the overall effective length of the cylinder and piston assembly. In the locked condition, the cylinder and piston assembly will effectively act as a solid link.

When actuated, the control valve will allow fluid to be removed from the cylinder which allows the piston free travel within the cylinder whether displacing hydraulic fluid to or from the reservoir or not. This will unlock the cylinder and piston assembly allowing the one of the wheels relative to which the anti-sway bar is connected to move independently of the other as well as providing an increased wheel travel.

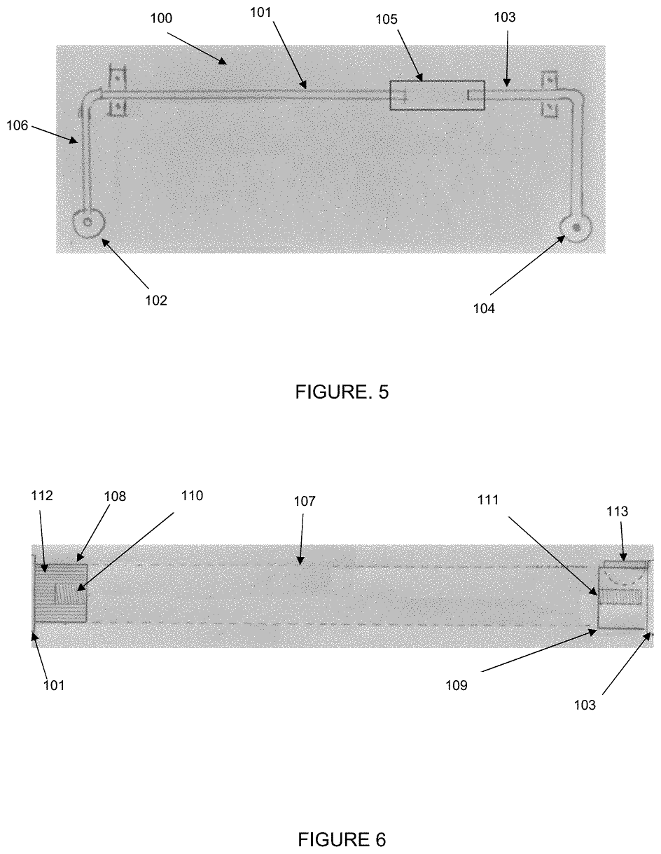

FIG. 5 illustrates a schematic view of an anti-sway bar assembly 100 according to an embodiment of the present invention. The assembly 100 includes a first anti-sway bar member 101 associated with a first wheel 102 of a vehicle and a second anti-sway bar member 103 associated with an opposed second wheel 104 of the vehicle. The anti-sway bar assembly 100 further comprises a connection assembly 105 associated with ends of both the first anti-sway bar member 101 and the second anti-sway bar member 103.

In the embodiment of the invention shown in FIG. 5, the first wheel 102 and the second wheel 104 are provided at opposite ends of the same axle 106.

FIG. 6 is a schematic view of a first anti-sway bar member 101 and a second anti-sway bar member 103 according to an embodiment of the present invention. In this Figure, it will be note that a portion of the anti-sway bar represented by broken lines 107 has been removed so that a gap is present between an end of the first anti-sway bar member 101 and the end of the second anti-sway bar member 103.

The end region 108 of the first anti-sway bar member 101 and the end region 109 of the second anti-sway bar member 103 are shaped so as to be received and retained in the connection portion (not shown in this Figure). In the embodiment of the invention shown in FIG. 6, the end regions 108, 109 are of reduced diameter in comparison to the first anti-sway bar member 101 and the second anti-sway bar member 103. Thus, the end regions 108, 109 are configured to be received in receiving portions in the connection portion (not shown in this Figure).

In addition, both of the end regions 108, 109 include internally screw-threaded bores 110, 111 respectively configured to receive complementary screw-threaded portions of the connection portion (not shown in this Figure) in order to join the first anti-sway bar member 101 and the second anti-sway bar member 103 to the connection portion (not shown in this Figure).

It may also be seen in this Figure that the end region 108 of the first anti-sway bar member 101 is provided with a splined outer surface 112 configured to engage with a splined inner surface of the first connection portion (not shown in this Figure) so as to substantially preclude the ability of the first connection portion to rotate relative to the first anti-sway bar member 101. Similarly, the end region 109 of the second anti-sway bar member 103 is provided with a Woodruff key 113 in an outer surface thereof. The Woodruff key 113 engages with an inner surface of the second connection portion (not shown in this Figure) in order to substantially preclude the ability of the second connection portion to rotate relative to the second anti-sway bar member 103.

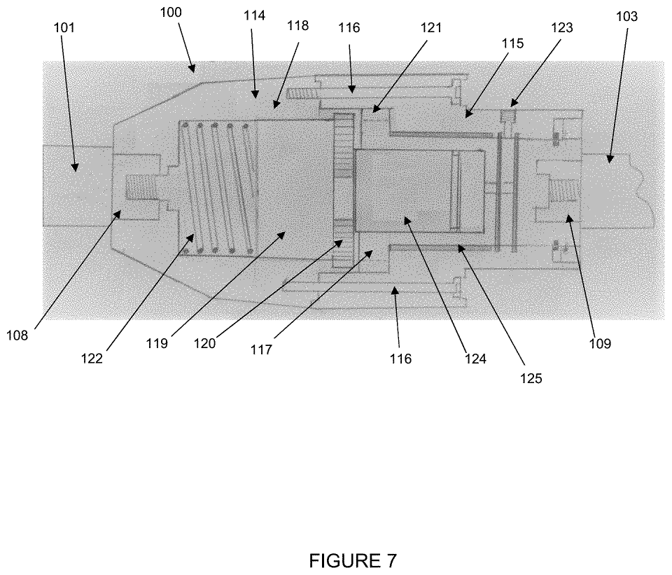

FIG. 7 is a cross-sectional view of an anti-sway bar assembly 100 according to an embodiment of the present invention. In this Figure, it may be seen that the end region 108 of the first anti-sway bar member 101 is connected to a first connection portion 114, while the end region 109 of the second anti-sway bar member 103 is connected to a second connection portion 115.

The first connection portion 114 and the second connection portion 115 are connected to one another by a pair of bolts 116, such that the first connection portion 114 and the second connection portion 115 together form a housing. The housing is provided with a cavity 117 at the interior thereof.

Located within the cavity 117 is the actuation mechanism 118. The actuation mechanism 118 comprises an engagement member 119 in the form of a piston. A portion of the outer surface 120 of the piston 119 is splined so as to engage with a splined inner surface 121 of the second connection portion 115. When the splined outer surface 120 of the piston 119 is engaged with the splined inner surface 121 of the second connection portion, the anti-sway bar assembly 100 is in the use condition such that the first anti-sway bar member 101 and the second anti-sway bar member 103 are configured to rotate in concert with one another.

The piston 119 is naturally biased into the use condition by a biasing member in the form of spring 122. When a user wishes to disengage the piston 119 from the inner surface 121 of the second connection portion 115, the user actuates a flow of pressurised fluid (air, water, oil or the like) from a reservoir (not shown) through inlet 123. The pressurised fluid exerts a force on an actuation member 124 in the form of a piston that acts against the engagement member 119. The force exerted by the pressurised fluid o the actuation member 124 is sufficient to overcome the natural bias of the spring 122, thereby moving the splined outer surface 120 of the engagement member 119 out of engagement with the splined inner surface 121 of the second connection portion 115 and into the released condition.

When in the released condition, the first anti-sway bar member 101 and the second anti-sway bar member 103 are disconnected from one another, and therefore do not rotate in concert with one another.

In the embodiment of the invention shown in FIG. 7, a sleeve member 125 is located within the second connection portion 115. The actuation member 124 is located within the sleeve member 124 and it is envisaged that the sleeve member 124 will rotate relative to the second connection portion 115 when the assembly 100 is in the released condition.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An anti-sway bar assembly for a vehicle, the anti-sway bar assembly including:
a first anti-sway bar member associated, at a first end thereof, with a first wheel of the vehicle;
a second anti-sway bar member associated, at a first end thereof, with an opposed second wheel of the vehicle; and
a connection assembly associated with a second end of each of the first anti-sway bar member and the second anti-sway bar member, the connection assembly configured for movement between a use condition in which the first anti-sway bar member and the second anti-sway bar member are connected to one another, and a released condition in which the first anti-sway bar member and the second anti-sway bar member are disconnected from one another.

2. The anti-sway bar assembly of claim 1 wherein the first anti-sway bar member and the second anti-sway bar member are associated with an axle of the vehicle, and wherein the first wheel and the second wheel are provided at opposed ends of the axle.

3. The anti-sway bar assembly of claim 1 wherein the first anti-sway bar member and the second anti-sway bar member comprise portions of the same anti-sway bar.

4. The anti-sway bar assembly of claim 1 wherein the connection assembly comprises a first connection portion configured for connection to the first anti-sway bar member and a second connection portion configured for connection to the second anti-sway bar member.

5. The anti-sway bar assembly of claim 4 wherein an end region of the first anti-sway member is shaped so as to be received and retained in a receiving portion of the first connection member and/or and end region of the second anti-sway member is shaped so as to be received and retained in a receiving portion of the second connection member.

6. The anti-sway bar assembly of claim 4 wherein the first connection portion and the second connection portion are configured to be retained in connection with one another in both the use condition and the released condition.

7. The anti-sway bar assembly of claim 6 wherein the first connection portion and the second connection portion together define a housing of the connection assembly.

8. The anti-sway bar assembly of claim 7 wherein the connection assembly further comprises an actuation mechanism located within the housing.

9. The anti-sway bar assembly of claim 8 wherein the actuation mechanism includes one or more engagement members configured to engage with an inner surface of the housing so as to effectively connect the first anti-sway bar member to the second anti-sway bar member via the connection assembly.

10. The anti-sway bar assembly of claim 9 wherein the one or more engagement members comprises a piston configured for movement relative to the housing.

11. The anti-sway bar assembly of claim 10 wherein the piston is movable between an engaged condition in which the piston is engaged with and retained on an inner surface of the housing and a disengaged condition in which the piston is disengaged from the inner surface of the housing.

12. The anti-sway bar assembly of claim 11 wherein the piston moves in a substantially linear manner between the engaged condition and the disengaged condition.

13. The anti-sway bar assembly of claim 11 wherein the piston is biased into the engaged condition.

14. The anti-sway bar assembly of claim 8 wherein the actuation mechanism is provided with an actuation member configured to actuate movement of the one or more engagement members.

15. The anti-sway bar assembly of claim 14 wherein the actuation member abuts the one or more engagement members, such that movement of the actuation member relative to the housing produces a corresponding movement of the one or more engagement members.

16. The anti-sway bar assembly of claim 15 wherein a sleeve member is located within the housing to form a cylinder in which the actuation member is located.

17. The anti-sway bar assembly of claim 16 wherein a working fluid is introduced to the cylinder in order to move the actuation member relative to the housing.

18. The anti-sway bar assembly of claim 17 wherein a working fluid reservoir is provided in fluid communication with one or more working fluid connection ports on the housing.

19. The anti-sway bar assembly of claim 17 wherein the anti-sway bar assembly further comprises an actuable control valve configured for controlling movement of the working fluid within the assembly.

20. The anti-sway bar assembly of claim 17 wherein the working fluid is a hydraulic fluid or a pneumatic fluid.
